(19) United States
(12) Patent Application Publication
(10) Pub. No.: US 2004/0156659 A1
(43) Pub. Date: Aug. 12, 2004

(54) Color fusing apparatus

(75) Inventors: Takashi Ando, Yokohama (JP); Yuichi Takashima, Yokohama (JP)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/717,923

(22) Filed: Nov. 21, 2003

(30) Foreign Application Priority Data
Nov. 22, 2002 (JP) 2002-339188

(51) Int. Cl. G03G 15/20

(52) U.S. Cl. 399/323; 399/328

(57) ABSTRACT

A color fusing apparatus to fuse a color toner onto a recording medium by passing the recording medium through a nip formed by a heat roller and a press roller that press-contacts the heat roller, the press roller including at least one fusing roller to fuse the color toner onto the recording medium; and a separation roller, disposed at an outlet through which the recording medium exits the color fusing apparatus, to separate the recording medium from the heat roller.

### CROSS-REFERENCE TO RELATED APPLICATIONS

This application claims the benefit of Japanese Patent Application No. 2002-339188, filed Nov. 22, 2002, in the Japanese Intellectual Property Office, the disclosure of which is incorporated herein by reference.

### BACKGROUND OF THE INVENTION

1. Field of the Invention

The present invention relates to a color fusing apparatus for fusing a color toner onto a recording medium using a heat roller.

2. Description of the Related Art

In typical color image recording apparatuses, such as color laser printers, for example, by using a color fusing apparatus with a heat roller, a color toner placed on a recording medium is fused onto the recording medium.

The color fusing apparatus includes a heat roller, on which a rubber layer is installed on the outer circumferential surface of a metal core member. A heater is installed inside the heat roller. A press roller press-contacts the heat roller and has a rubber layer installed on the outer circumferential surface of another metal core member, so that a press-contact portion having a predetermined length (generally referred to as a “nip”) is formed. By rotating the heat roller to make the recording medium pass through the nip, the color toner melts in the nip area and fuses onto the recording medium as the heat roller press-contacts the recording medium.

The conventional color fusing apparatus described above is shown in detail in a published document entitled, “Color Laser Printer Technique,” revised by Haneta Satoshi, and published by Tricaps Corp. on Oct. 18, 1996.

However, in the conventional color fusing apparatus, because a plurality of color toners are deposited onto the recording medium, sufficiently melting the color toners in the nip and fusing the color toners on the recording medium is a required design condition (i.e., a fusing condition). When the color toners are not sufficiently melted, because the respective color toners are not mixed well, reproduction of the colors of a color image cannot be guaranteed.

Thus, in the conventional color fusing apparatus, to meet the above fusing condition, the heat roller and the press roller are designed to sufficiently obtain, for example, the length of the nip in a direction in which a recording medium is transferred, a heating temperature in the nip, and/or a press-contact force of the heat roller.

In the conventional color fusing apparatus, another design condition (i.e., a separation condition) is required to completely expel the recording medium after passing through the nip. That is, when a heat roller is used, because the recording medium tends to wind around a particular roller (mainly, the heat roller) that directly contacts the color toner due to adhesion of the color toner, the recording medium needs to be completely ejected from the color fusing apparatus by preventing the recording medium from winding around the heat roller.

Thus, in the conventional color fusing apparatus, to satisfy the separation condition, the heat roller and the press roller are designed to slightly increase an angle (hereinafter, referred to as the “separation angle”) made by the outer circumferential surface of the heat roller and a direction in which the recording medium exits through an outlet.

That is, the heat roller and the press roller in the conventional color fusing apparatus are designed together to satisfy both the fusing condition and the separation condition, while simultaneously satisfying another design condition (i.e., a size condition) concerning the limitations on the size of an object allowed in the color fusing apparatus.

However, because the respective design conditions are contrary to one another, the design of the heat roller and the press roller to satisfy both the fusing condition and the separation condition is difficult so that varying the design of the heat roller and the press roller is limited.

For example, to obtain a sufficient nip length, the diameter of each of the heat roller and the press roller needs to be relatively large. However, this increases the size of the color fusing apparatus and simultaneously decreases the separation angle so that the recording medium is easily wound around the heat roller. Furthermore, when the length of the nip is obtained by increasing the press-contact force at the nip, the recording medium may be easily wrinkled.

### SUMMARY OF THE INVENTION

To solve the above and/or other problems, the present invention provides a color fusing apparatus that obtains a sufficient nip to fuse toner on a recording medium, separately performs a separation function and a fusing function, and reduces the overall volume of the color fusing apparatus.

According to an aspect of the present invention, there is provided a color fusing apparatus to fuse a color toner onto a recording medium by passing the recording medium through a nip formed by a heat roller and a press roller that press-contacts the heat roller, the press roller including at least one fusing roller to fuse the color toner onto the recording medium; and a separation roller, disposed at an outlet through which the recording medium exits the color fusing apparatus, to separate the recording medium from the heat roller.

According to another aspect of the present invention, there is provided a color fusing apparatus to fuse a color toner onto a recording medium by passing the recording medium through a nip formed by a heat roller and a press roller that press-contacts the heat roller, the press roller including at least one fusing roller contacting the heat roller to fuse the color toner onto the recording medium; and a separation roller, disposed at an outlet through which the recording medium exits the color fusing apparatus, contacting the heat roller to separate the recording medium, which adheres to the heat roller, from the heat roller to eject the recording medium outside the color fusing apparatus.

According to another aspect of the present invention, there is provided an apparatus to fuse a color toner onto a recording medium, including a heat roller; a fusing roller contacting the heat roller to fuse the color toner onto the recording medium; and a separation roller separate from, and adjacent to, the fusing roller and contacting the heat roller to separate the recording medium from the separation roller.

According to another aspect of the present invention, there is provided an apparatus to fuse a color toner onto a recording medium, including a heat roller; two fusing rollers contacting the heat roller to fuse the color toner onto the recording medium; and a separation roller separate from the fusing rollers and contacting the heat roller to separate the recording medium from the separation roller.

Additional aspects and/or advantages of the invention will be set forth in part in the description that follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings, of which:

FIG. 1 is a view illustrating the structure of a heat roller and a press roller according to a first embodiment of the present invention;

FIG. 2 is a view illustrating the structure of a heat roller and a press roller according to a second embodiment of the present invention;

FIG. 3 is a view illustrating the structure of a heat roller and a press roller according to a third embodiment of the present invention;

FIG. 4 is a view illustrating the structure of a heat roller and a press roller according to a fourth embodiment of the present invention;

FIG. 5 is a view illustrating the structure of a heat roller and a press roller according to a fifth embodiment of the present invention; and

FIG. 6 is a view illustrating the structure of a heat roller and a press roller according to a sixth embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

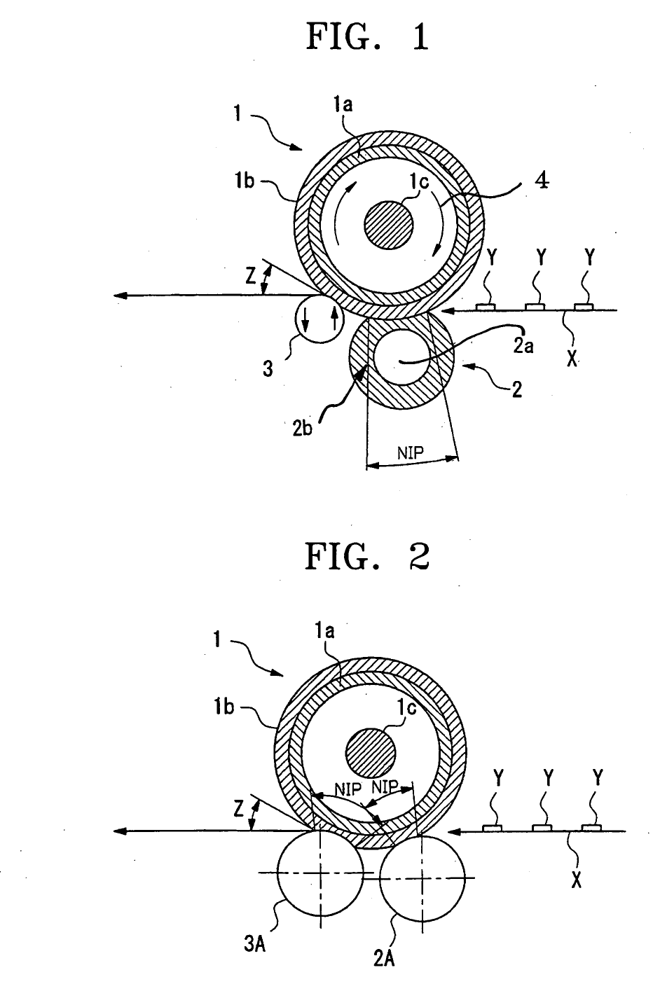

Referring to FIG. 1, a color fusing apparatus according to a first embodiment of the present invention includes a heat roller 1, a fusing roller 2 contacting the heat roller 1 to fuse a color toner Y onto a recording medium X, and a separation roller 3 contacting the heat roller 1 and placed adjacent to the fusing roller 2 in a direction in which the recording medium X, with the color toner Y fused thereon, exits the color fusing apparatus.

The heat roller 1 includes a metal core member 1a, a rubber layer 1b, and a heater 1c. That is, the heat roller 1 is a soft roller in which the rubber layer 1b, having a predetermined thickness, is provided on an outer circumferential surface of the cylindrical metal core member 1a, which is formed of aluminum. The heat roller 1 is rotated by a driving apparatus (not shown) as indicated by arrows 4 in FIG. 1.

The rubber layer 1b is made of a heat resistant rubber, such as silicon rubber or fluorine rubber, and is made by forming the heat resistant rubber around the metal core member 1a. Also, the heater 1c is installed inside the heat roller 1 and heats the color toner Y.

The fusing roller 2 and the separation roller 3 operate as press rollers forming a nip by press-contacting the heat roller 1. The recording medium X, to which the color toner Y is attached, is pressed while passing through the nip, so that the color toner Y is fused on the recording medium X.

The fusing roller 2 has a rubber layer 2b around the outer circumferential surface of a metal core member 2a. The diameters of the metal core member 6 of the fusing roller 2 and the separation roller 3 are identical and much smaller than the diameter of the heat roller 1, as shown in FIG. 1.

As the heat roller 1 rotates clockwise as shown in FIG. 1, the recording medium X passes through a first nip formed by the heat roller 1 and the fusing roller 2 and through a second nip formed by the heat roller 1 and the separation roller 3, and the color toner Y adheres to the upper surface of the recording medium X.

The color toner Y is made of a plurality of color toners deposited in a predetermined ratio. A desired color (a mixed color) is obtained as the respective color toners are sufficiently melted and/or mixed as the color toner Y passes through each nip.

The fusing roller 2 is disposed at an entrance of the recording medium X and is a press roller designed to meet a priority design condition, which is a fusing operation that fuses the color toner Y onto the recording medium X. The fusing roller 2 is a soft roller made by installing the rubber layer 2b having a particular thickness on the outer circumferential surface of the cylindrical metal core member 2a, which is formed of aluminum. The rigidity of the fusing roller 2 is less than that of the rubber layer 1b of the heat roller 1.

The separation roller 3 is disposed at the outlet through which the recording medium X exits and is a press roller designed to meet a priority design condition, which is a separation operation that separates the recording medium X from the heat roller 1. The separation roller 3 is a soft roller made by installing a rubber layer (not shown) having a particular thickness on an outer circumferential surface of a cylindrical metal core member, which is formed of aluminum. The rigidity of the separation roller 3 is greater than that of the rubber layer 1b of the heat roller 1.

The rubber layer 2b of the fusing roller 2 and the rubber layer of the separation roller 3 are made of a heat resistant rubber, such as silicon rubber or fluorine rubber, and are made by forming the heat resistant rubber around the metal core member.

The operation and effects of the color fusing apparatus having the above structure according to the first embodiment of the present invention are described below.

The recording medium X, supplied from right to left in FIG. 1, passes through the first nip formed by the heat roller 1 and the fusing roller 2 as the heat roller 1 rotates clockwise. Then, the recording medium X passes through the second nip formed by the heat roller 1 and the separation roller 3 and exits the color fusing apparatus.

That is, while passing through the first nip and the second nip, the color toner Y is sufficiently melted to obtain a color representation and is simultaneously fused on the recording medium X. The recording medium X with the fused color toner Y is ejected between the heat roller 1 and the separation roller 3 and exits toward the left side of FIG. 1.

In realizing the fusing of the color toner Y on the recording medium X, the fusing roller 2 is designed such that a desired nip length is obtained between the heat roller 1 and the fusing roller 2. That is, although the main purpose of the press roller of the conventional color fusing apparatus is to provide both a fusing operation and a separation operation, the rigidity of the rubber layer 2b of the fusing roller 2 is designed to form a desired nip length without considering the separation condition.

In contrast, the separation roller 3 satisfies the separation condition in that the rigidity of the rubber layer of the separation roller 3 is set to be greater than that of the rubber layer 1b of the heat roller 1. Accordingly, an angle (a separation angle Z) formed by the heat roller 1 and the recording medium X at the outlet is set so that the recording medium X is easily separated from the heat roller 1.

While the conventional color fusing apparatus is designed to meet both the fusing condition and the separation condition with a single press roller, in the color fusing apparatus according to the present invention, by setting the rigidity of the respective rubber layers 1b, 2b, and the rubber layer of the separation roller 3, the separation roller 3 mainly performs the separation operation and the fusing roller 2 mainly performs the fusing operation. That is, the separation and fusing operations are distributed in the present invention.

In the color fusing apparatus according to the first embodiment of the present invention, the first nip and the second nip are respectively formed using two press rollers that are soft rollers, that is, the fusing roller 2 and the separation roller 3, to provide sufficient lengths for the two nips, and the diameters of the metal core members of the fusing roller 2 and the separation roller 3 are substantially less than the diameter of the heat roller 1.

In the conventional color fusing apparatus according to the first embodiment of the present invention, because the nip length is realized using a single press roller, the diameter of the press roller cannot be decreased. However, in the color fusing apparatus according to the first embodiment of the present invention, because two nip lengths can be realized using the fusing roller 2 and the separation roller 3 with smaller diameters, the limitation in reducing the size of the color fusing apparatus can be overcome.

Furthermore, although only one fusing roller 2 is provided in the first embodiment of the present invention, more than one fusing roller may be used. Also, although in the first embodiment of the present invention the diameters of the fusing roller 2 and the separation roller 3 are the same, the diameters may differ from one another.

FIG. 2 shows the structure of a heat roller and a press roller (including a fusing roller and a separation roller) according to a second embodiment of the present invention. In FIG. 2, elements corresponding to those in FIG. 1 are represented by the same reference numerals.

The second embodiment of the present invention differs from the first embodiment in that a fusing roller 2A and a separation roller 3A are hard rollers, and the press-contact forces of the fusing roller 2A and the separation roller 3A with respect to the heat roller 1 are set using different considerations, as described below.

In the second embodiment of the present invention, the fusing roller 2A and the separation roller 3A are metal rollers (hard rollers) formed of aluminum and have a rigidity that is greater than that of the heat roller 1, which is a soft roller. Also, the press-contact force of the fusing roller 2A with respect to the heat roller 1 is set such that the color toner Y is fused onto the recording medium X. The press-contact force of the separation roller 3A at the outlet is set such that the recording medium X is separated from the heat roller 1.

That is, the press-contact force of the separation roller 3A is set so that the recording medium X is separated more surely at the outlet, which determines the length of the nip formed by the separation roller 3A and the heat roller 1. The press-contact force of the fusing roller 2A is set to realize the desired length of the nip formed by the fusing roller 2A and the heat roller 1, compensating for the lack of the nip length formed using the fusing roller 2A.

According to the second embodiment of the present invention, the color toner Y is sufficiently melted and/or fused by the total length of both nips formed using the fusing roller 2A and the separation roller 3A, respectively.

Because the press-contact force of the separation roller 3A having a rigidity greater than that of the heat roller 1 is set considering only the separation of the recording medium X from the heat roller 1, the separation angle Z is increased at the outlet so that the recording medium X is easily separated from the heat roller 1.

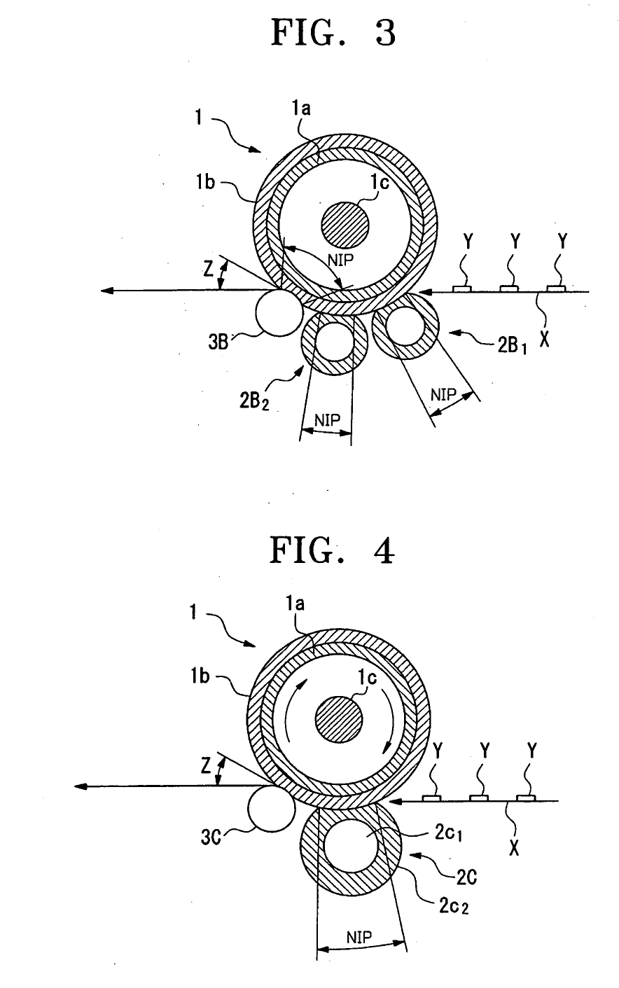

FIG. 3 shows the structure of a heat roller and a press roller (including two fusing rollers, and a separation roller) according to a third embodiment of the present invention. In FIG. 3, elements corresponding to those in FIG. 1 are represented by the same reference numerals.

The third embodiment of the present invention differs from the first embodiment in that two fusing rollers 2B₁, and 2B₂ are used and a separation roller 3B is a hard roller.

In the third embodiment, although each of the fusing rollers 2B₁ and 2B₂ has the same structure as that of the fusing roller 2 of the first embodiment, the diameter of each of the fusing rollers 2B₁, and 2B₂ is less than that of the fusing roller 2. Also, the diameter of the separation roller 3B is less than that of the separation roller 3 of the first embodiment.

According to the third embodiment of the present invention, because two fusing rollers 2B₁, and 2B₂ and one separation roller 3B are provided in place of the single press roller of the conventional color fusing apparatus and nips are formed at three positions using the fusing rollers 2B₁, and 2B₂ and the separation roller 3B, respectively, required nip lengths can be obtained even when the fusing rollers 2B₁, and 2B₂ and the separation roller 3B are small in diameter. Also, because the separation angle Z at the outlet can be made sufficiently large by the separation roller 3B having a rigidity that is greater than that of the heat roller 1, which is a soft roller, the recording medium X can be surely separated from the heat roller 1.

Furthermore, because the fusing rollers 2B₁, and 2B₂ and the separation roller 3B are smaller than the fusing roller 2 and the separation roller 3 of the first embodiment, the third embodiment of the present invention can effectively reduce the size of the color fusing apparatus.

FIG. 4 shows the structure of a heat roller and a press roller (including a fusing roller and a separation roller) according to a fourth embodiment of the present invention. In FIG. 4, elements corresponding to those in FIG. 1 are represented by the same reference numerals.

The fourth embodiment of the present invention differs from the first embodiment in that a fusing roller 2C, which is a soft roller, is larger than a separation roller 3C, which is a hard roller as in the third embodiment.

In the fourth embodiment, the fusing roller 2C has a rubber layer 2c₂ around the outer circumferential surface of a metal core member 2c₁. The diameter of the fusing roller 2C is greater than that of the fusing roller 2 of the first embodiment and the rigidity of the fusing roller 2C is less than that of the fusing roller 2 of the first embodiment. That is, the length of a nip formed by the fusing roller 2C and the heat roller 1 is greater than that of the nip formed by the fusing roller 2 and the heat roller 1 in the first embodiment. The diameter of the separation roller 3C is smaller than that of the separation roller 3 of the first embodiment. Thus, the nip formed using the fusing roller 2C compensates for the decrease in the length of the nip formed by the separation roller 3C and the heat roller 1.

The separation roller 3C is a cylindrical metal roller (a hard roller) formed of aluminum and has a greater rigidity and smaller diameter than those of the heat roller 1. Thus, because the separation roller 3C can increase the separation angle Z at the outlet, the recording medium X can be surely separated from the heat roller 1.

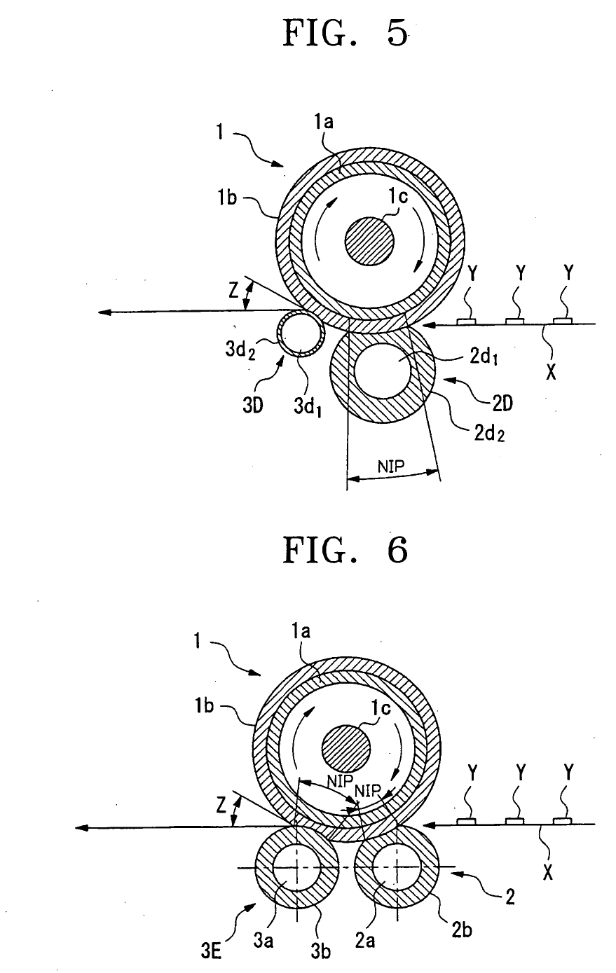

FIG. 5 shows the structure of a heat roller and a press roller (including a fusing roller and a separation roller) according to a fifth embodiment of the present invention. In FIG. 5, elements corresponding to those in FIG. 1 are represented by the same reference numerals.

The fifth embodiment of the present invention differs from the fourth embodiment in that a separation roller 3D is a soft roller.

The separation roller 3D has a rubber layer 3d₂, having a rigidity greater than that of the rubber layer 1b of the heat roller 1, on a circumferential surface of a cylindrical metal core member 3d₁, which is formed of aluminum. Because the separation roller 3D has a rigidity less than that of the separation roller 3C of the fourth embodiment, but sufficiently greater than that of the heat roller 1, the separation angle Z at the outlet is increased. As a result, the recording medium X is surely separated from the heat roller 1.

FIG. 6 shows the structure of a heat roller and a press roller (including a fusing roller and a separation roller) according to a sixth embodiment of the present invention. In FIG. 6, elements corresponding to those in FIG. 1 are represented by the same reference numerals.

The sixth embodiment of the present invention differs from the fourth embodiment in that a separation roller 3E is a drive roller.

That is, in the sixth embodiment, as shown in FIG. 6, because the separation roller 3E is reversely driven with respect to the heat roller 1, such that the circumferential speed of the separation roller 3E is greater than that of the heat roller 1, a portion of the recording medium X contacting the separation roller 3E and the heat roller 1 is pulled toward the direction in which the recording medium exits. As a result, the portion of the recording medium X placed between the separation roller 3E and the fusing roller 2E is pressed against the circumferential surface of the heat roller 1, as if passing through a nip.

Thus, the separation roller 3E may be a hard roller or a soft roller like the separation roller 3D of the fifth embodiment. For the separation roller 3E that is a soft roller, because a frictional force of the circumferential surface of the separation roller 3E increases so that the recording medium X is pulled without slipping in the direction in which the recording medium exits, a force pressing the recording medium X against the outer circumferential surface of the heat roller 1 increases, providing an effect similar to that of passing the recording medium X through a nip.

As described above, because the color fusing apparatus according to the embodiments of the present invention includes a press roller having one or more fusing rollers to fuse color toner on a recording medium and a separation roller disposed at an outlet through which the recording medium exits to separate the recording medium from a heat roller, the heat roller and the press roller can be more freely designed. Thus, a color fusing apparatus satisfying various design conditions is provided by the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A color fusing apparatus to fuse a color toner onto a recording medium by passing the recording medium through a nip formed by a heat roller and a press roller that press-contacts the heat roller, the press roller comprising:
at least one fusing roller to fuse the color toner onto the recording medium; and
a separation roller, disposed at an outlet through which the recording medium exits the color fusing apparatus, to separate the recording medium from the heat roller.

2. The color fusing apparatus of claim 1, wherein the at least one fusing roller and the separation roller each have greater rigidity than the heat roller.

3. The color fusing apparatus of claim 2, wherein the rigidity of the separation roller is greater than that of the heat roller to form an angle at the outlet between the heat roller and a direction of propagation of the recording medium to separate the recording medium from the heat roller.

4. The color fusing apparatus of claim 2, wherein the heat roller, the at least one fusing roller, and the separation roller are soft rollers, each soft roller comprising a metal core member and a soft member that is softer than metal and installed on an outer circumferential surface of the metal core member, the heat roller, the at least one fusing roller, and the separation roller respectively heating the color toner, fusing the color toner onto the recording medium, and separating the recording medium from the heat roller by the rigidity of each respective soft member.

5. The color fusing apparatus of claim 2, wherein the heat roller and the at least one fusing roller are softer rollers, each soft roller comprising a metal core member and a soft member that is softer than metal and installed on an outer circumferential surface of the metal core member.

6. The color fusing apparatus of claim 5, wherein the separation roller is a metal roller.

7. The color fusing apparatus of claim 6, wherein the separation roller is reversely driven with respect to the heat roller that rotates to transfer the recording medium through the color fusing apparatus.

8. The color fusing apparatus of claim 5, wherein the separation roller is a soft roller comprising a metal core member and a soft member, having a rigidity greater than the soft member of the heat roller, that is installed on an outer circumferential surface of the metal core member of the separation roller.

9. The color fusing apparatus of claim 1, wherein the separation roller has a rigidity greater than that of the heat roller, the at least one fusing roller has a press-contact force sufficient to fuse the color toner on the recording medium, and the separation roller has a press-contact force sufficient to separate the recording medium from the heat roller.

10. The color fusing apparatus of claim 9, wherein the press-contact force of the separation roller with respect to the heat roller creates a separation angle between the heat roller and a direction of propagation of the recording medium to separate the recording medium from the heat roller.

11. The color fusing apparatus of claim 9, wherein the heat roller is a soft roller comprising a metal core member and a soft member that is softer than metal and installed on an outer circumferential surface of the metal core member.

12. The color fusing apparatus of claim 11, wherein the separation roller is a metal roller.

13. The color fusing apparatus of claim 9, wherein the separation roller is a metal roller.

14. The color fusing apparatus of claim 10, wherein the separation roller is a metal roller.

15. The color fusing apparatus of claim 12, wherein the at least one fusing roller is a metal roller.

16. The color fusing apparatus of claim 11, wherein the at least one fusing roller is a metal roller.

17. The color fusing apparatus of claim 9, wherein the at least one fusing roller is a metal roller.

18. The color fusing apparatus of claim 13, wherein the at least one fusing roller comprises a plurality of soft rollers, each soft roller comprising a metal core member and a soft member that is softer than metal and installed on an outer circumferential surface of the metal core member.

19. The color fusing apparatus of claim 12, wherein the at least one fusing roller comprises a plurality of soft rollers, each soft roller comprising a metal core member and a soft member that is softer than metal and installed on an outer circumferential surface of the metal core member.

20. A color fusing apparatus to fuse a color toner onto a recording medium by passing the recording medium through a nip formed by a heat roller and a press roller that press-contacts the heat roller, the press roller comprising:
at least one fusing roller contacting the heat roller to fuse the color toner onto the recording medium; and
a separation roller, disposed at an outlet through which the recording medium exits the color fusing apparatus, contacting the heat roller to separate the recording medium, which adheres to the heat roller, from the heat roller to eject the recording medium outside the color fusing apparatus.

21. The color fusing apparatus of claim 20, wherein the heat roller is a soft roller comprising a metal core member and a soft member that is softer than the metal core member and installed on an outer circumferential surface of the metal core member and the at least one fusing roller and the separation roller have rigidities different from that of the heat roller.

22. The color fusing apparatus of claim 20, wherein the separation roller has a rigidity greater than that of the heat roller to create a separation angle, between the heat roller and a direction of propagation of the recording medium, at the outlet through which the recording medium exits to separate the recording medium from the heat roller.

23. The color fusing apparatus of claim 22, wherein the at least one fusing roller and the separation roller are soft rollers, each soft roller comprising a metal core member and a soft member that is softer than metal and installed on an outer circumferential surface of the metal core member.

24. The color fusing apparatus of claim 22, wherein the at least one fusing roller and the separation roller are metal rollers.

25. The color fusing apparatus of claim 22, wherein the at least one fusing roller is a soft roller comprising a metal core member and a soft member that is softer than metal and installed on an outer circumferential surface of the metal core member.

26. The color fusing apparatus of claim 22, wherein the separation roller is a metal roller.

27. The color fusing apparatus of claim 22, wherein the separation roller is a soft roller comprising a metal core member and a soft member that is softer than metal and installed on an outer circumferential surface of a metal core member.

28. The color fusing apparatus of claim 22, wherein the separation roller is reversely driven with respect to the heat roller that rotates to transfer the recording medium through the color fusing apparatus.

29. The color fusing apparatus of claim 21, wherein the at least one fusing roller and the separation roller are soft rollers, each soft roller comprising a metal core member and a soft member that is softer than metal and installed on an outer circumferential surface of the metal core member.

30. The color fusing apparatus of claim 21, wherein the at least one fusing roller and the separation roller are metal rollers.

31. The color fusing apparatus of claim 21, wherein the at least one fusing roller is a soft roller comprising a metal core member and a soft member that is softer than metal and installed on an outer circumferential surface of the metal core member.

32. The color fusing apparatus of claim 21, wherein the separation roller is a metal roller.

33. The color fusing apparatus of claim 21, wherein the separation roller is a soft roller comprising a metal core member and a soft member that is softer than metal and installed on an outer circumferential surface of a metal core member.

34. The color fusing apparatus of claim 21, wherein the separation roller is reversely driven with respect to the heat roller that rotates to transfer the recording medium through the color fusing apparatus.

35. An apparatus to fuse a color toner onto a recording medium, comprising:
a heat roller;
a fusing roller contacting the heat roller to fuse the color toner onto the recording medium; and
a separation roller separate from, and adjacent to, the fusing roller and contacting the heat roller to separate the recording medium from the separation roller.

36. The apparatus of claim 35, wherein the heat roller, the fusing roller, and the separation roller are soft rollers.

37. The apparatus of claim 36, wherein a diameter of the fusing roller is about the same as a diameter of the separation roller, and the diameter of the fusing roller and the diameter of the separation roller are each less than a diameter of the heat roller.

38. The apparatus of claim 36, wherein a rigidity of the fusing roller is less than a rigidity of the heat roller and a rigidity of the separation roller is greater than the rigidity of the heat roller.

39. The apparatus of claim 35, wherein the heat roller is a soft roller and the fusing roller and the separation roller are hard rollers.

40. The apparatus of claim 39, wherein a rigidity of the fusing roller and a rigidity of the separation roller are respectively greater than a rigidity of the heat roller.

41. The apparatus of claim 35, wherein the heat roller and the fusing roller are soft rollers and the separation roller is a hard roller.

42. The apparatus of claim 41, wherein a diameter of the separation roller is less than both a diameter of the fusing roller and a diameter of the heat roller, and a rigidity of the separation roller is greater than a rigidity of the heat roller.

43. The apparatus of claim 35, wherein a rigidity of the separation roller is greater than a rigidity of the heat roller.

44. The apparatus of claim 35, wherein the separation roller is a drive roller that is reversely driven with respect to the heat roller, wherein a circumferential speed of the separation roller is greater than that of the heat roller, which pulls a portion of the recording medium contacting the separation roller and the heat roller in a direction in which the recording medium exits the color fusing apparatus and presses a portion of the recording medium between the separation roller and the fusing roller against the heat roller.

45. The apparatus of claim 35, further comprising a first nip formed where the fusing roller contacts the heat roller and a second nip formed where the separation roller contacts the heat roller, wherein the color toner is melted and fused onto the recording medium as the recording medium passes through the first nip and the recording medium is separated from the heat roller as the recording medium passes through the second nip.

46. The apparatus of claim 45, wherein the heat roller, the fusing roller, and the separation roller each comprises a metal core member and a rubber layer wrapped around the metal core member, wherein a length of the first nip and a length of the second nip are determined according to respective rigidities of each of the rubber layers.

47. The apparatus of claim 45, wherein the heat roller comprises a metal core member and a rubber layer wrapped around the metal core member, wherein a length of the first nip and a length of the second nip are determined according to a rigidity of the rubber layer and respective contact forces of the fusing roller and the separation roller on the heat roller.

48. The apparatus of claim 47, wherein the length of the second nip is determined to separate the recording medium from the heat roller, and the contact force of the fusing roller is set to obtain the length of the first nip that compensates for the length of the second nip.

49. The apparatus of claim 45, wherein a length of the first nip is greater than a length of the second nip.

50. An apparatus to fuse a color toner onto a recording medium, comprising:
a heat roller;
two fusing rollers contacting the heat roller to fuse the color toner onto the recording medium; and
a separation roller separate from the fusing rollers and contacting the heat roller to separate the recording medium from the separation roller.

51. The apparatus of claim 50, wherein the heat roller and the fusing rollers are soft rollers and the separation roller is a hard roller, and a rigidity of the separation roller is greater than that of the heat roller.

52. The apparatus of claim 50, further comprising nips formed respectively where each fusing roller contacts the heat roller and where the separation roller contacts the heat roller, wherein the color toner is melted and fused onto the recording medium as the recording medium passes through the nips formed using the fusing rollers and the recording medium is separated from the heat roller as the recording medium passes through the nip formed using the separation roller.
